(19) United States
(12) Patent Application Publication
(10) Pub. No.: US 2015/0056347 A1
(43) Pub. Date: Feb. 26, 2015

(54) FOOD PRODUCTS HAVING AN IMPROVED APPEAL TO PET OWNERS AND AT LEAST A MAINTAINED PALATABILITY TO PETS, AND METHODS OF PREPARATION

(71) Applicant: SPECIALITES PET FOOD, Elven (FR)

(72) Inventors: Magali Fournier, Vannes (FR); Howard John Munt, Thoiry (FR); Mark Rubin, Thoiry (FR); Cécile Moreau, St German Les Corbeil (FR)

(73) Assignees: SPECIALITES PET FOOD, Elven (FR); FIRMENICH S.A., Geneva (CH)

(21) Appl. No.: 14/389,286

(22) PCT Filed: Mar. 29, 2013
(86) PCT No.: PCT/EP2013/056834

§ 371 Date: Sep. 29, 2014

Related U.S. Application Data
(60) Provisional application No. 61/618,038, filed on Mar. 30, 2012.

(51) Int. Cl. A23K 1/18; A23K 1/16; A23K 1/00

(52) U.S. Cl. CPC A23K 1/1846; A23K 1/004; A23K 1/16
USPC 426/302

(57) ABSTRACT

The present invention relates to the use of a palatability-enhancing composition comprising at least one dry food aroma and at least one pet food palatability enhancer in a pet food product, for improving appeal to pet owners while at least maintaining palatability to pets of said pet food product, in comparison with said pet food product which does not comprise said dry food aroma.

### FIELD OF THE INVENTION

The present invention relates to the field of pet food. More specifically, the present invention is related to palatability-enhancing compositions useful for preparing food products for pet, said food products having an improved appeal to pet owners while at least a maintained palatability to pets.

### BACKGROUND TO THE INVENTION

The pet food industry has a long-standing desire to provide food products that not only have a high nutritional value but also are palatable to pets.

Many pet foods proposed so far have a major disadvantage due to the presence of smells that are not appealing to the pet owners. Reciprocally, food products that are attractive to pet owners are not systematically palatable to pets. Indeed, many pets are finicky eaters. Hence, a high palatability level of pet food products is required to be consumed by pets.

Some food products have yet been described in the art as being attractive to both pets and humans.

For example, U.S. Pat. No. 3,898,345 of Aug. 5, 1975 describes a an artificial meat-like protein food having the aroma and the color closely resembling those of cooked muscle meat, so that the food product has a high degree of acceptance by both humans and pets.

Yet another example is pet foods, in particular biscuit-type treats, using algal or fungal waste-containing fatty acids, as disclosed in U.S. Pat. No. 6,338,866 of Jan. 15, 2002.

In European patent application No. EP 2 095 723 published on Sep. 2, 2009, further examples of pet food products in the form of human delicatessen are disclosed as being more appealing to pet owners. These food products contain a combination of real meat, real vegetables, real grain and pasta, and are provided in specifically-designed container systems.

There is thus a need in the art for new pet food products that are not only palatable to pets but also appealing to pet owners.

### SUMMARY OF THE INVENTION

The present invention provides using a palatability-enhancing composition comprising or consisting of at least one dry food aroma and at least one pet food palatability enhancer for preparing a pet food product having an improved appeal to pet owners while at least a maintained palatability to pets, in comparison with said pet food product which does not comprise said dry food aroma, in particular in comparison with said pet food product which comprises said food aroma in its liquid form.

The invention also relates to the use of such palatability-enhancing composition in a pet food product, for improving appeal to pet owners while at least maintaining palatability to pets of said pet food product, in comparison with said pet food product which does not comprise said dry food aroma, in particular in comparison with said pet food product which comprises said food aroma in its liquid form.

The present invention also provides a palatability-enhancing composition comprising at least one dry food aroma and at least one pet food palatability enhancer, as an intermediate product for preparing a pet food product having an improved appeal to pet owners while at least maintained palatability to pets, in comparison with said pet food product which does not comprise said dry food aroma, in particular in comparison with said pet food product which comprises said food aroma in its liquid form.

The present invention further relates to methods for preparing such palatability-enhancing compositions and such pet food products.

The present invention also concerns said pet food products having an improved appeal to pet owners while at least a maintained palatability to pets.

The present invention also relates to a method for improving appeal to pet owners while at least maintaining palatability to pets of a pet food product.

### DETAILED DESCRIPTION OF THE INVENTION

### Definitions

Percentages are expressed herein by weight of a product reference (in particular, a palatability enhancer (PE) or a palatability-enhancing composition (PEC). In some instances that will be apparent to the person skilled in the art, percentages may be expressed on a dry matter basis. The person skilled in the art will appreciate that the term “dry matter basis” means that an ingredient's concentration or percentage in a composition is measured after the free water has been removed, or determined on the basis of the weight of the composition once the weight of any free moisture in the composition has been subtracted.

In the present disclosure, ranges are stated in shorthand, so as to avoid having to set out at length and describe each and every value within the range. Any appropriate value within the range can be selected, where appropriate, as the upper value, lower value, or the terminus of the range. For example, a range of 0.1-1.0 represents the terminal values of 0.1 and 1.0, as well as the intermediate values of 0.2, 0.3, 0.4, 0.5, 0.6, 0.7, 0.8, 0.9, and all intermediate ranges encompassed within 0.1-1.0, such as 0.2-0.5, 0.2-0.8, 0.7-1.0, etc.

As used throughout, the singular form of a word includes the plural, and vice versa, unless the context clearly dictates otherwise. Thus, the references “a”, “an”, and “the” are generally inclusive of the plurals of the respective terms. For example, reference to “a method” or “a food” includes a plurality of such “methods” or “foods”. Similarly, the words “comprise”, “comprises”, and “comprising” are to be interpreted inclusively. Likewise the terms “include”, “including” and “or” should all be construed to be inclusive. All these terms however have to be considered as encompassing exclusive embodiments that may also be referred to using words such as “consist of”.

The methods and compositions and other embodiments exemplified here are not limited to the particular methodologies, protocols, and reagents that are described herein because, as the skilled artisan will appreciate, they may vary.

Unless defined otherwise, all technical and scientific terms, terms of art, and acronyms used herein have the meanings commonly understood by the skilled artisan in the field(s) of the invention, or in the field(s) where the term is used. Although any compositions, methods, articles of manufacture, or other means or materials similar or equivalent to those described herein can be used in the practice of the present invention, the preferred compositions, methods, articles of manufacture, or other means or materials are described herein.

The term “about” as used herein when referring to a measurable value such as an amount, a temporal duration, and the like, is meant to encompass variations of ±20%, more preferably ±10%, even more preferably ±5% from the specified value, as such variations are appropriate to reproduce the disclosed methods and products.

The term “palatability” means a relative preference of an animal for one food product to another. Palatability refers to the overall willingness of an animal to eat a certain food product. Advantageously but not necessarily, palatability further refers to the capacity of the eaten food product to satisfy the animal. Whenever an animal shows a preference, for example, for one of two or more food products, the preferred food product is more “palatable”, and has “enhanced palatability”. The relative palatability of one food product compared to one or more other food products can be determined, for example, in side-by-side, free-choice comparisons, e.g., by relative consumption of the food products, or other appropriate measures of preference indicative of palatability. It can advantageously be determined by a standard testing protocol in which the animal has equal access to both food products such as a test called “two-bowl test” or “versus test” (see below). Such preference can arise from any of the animal's senses, but typically is related to, inter alia, taste, aftertaste, smell, mouth feel and/or texture.

The terms “palatability enhancers” (PEs), “palatants”, “palatability agents”, “appetizing factors”, and any other similar terms mean any material that enhances the palatability of a food product to an animal. A PE may be a single material or a blend of materials, and it may be natural, processed or unprocessed, synthetic, or part of natural and part of synthetic materials. Typically, a PE for animal food is a liquid or dry edible composition that provides a taste, aftertaste, smell, mouth feel, texture, and/or organoleptic sensation that is pleasant to the target animal.

For pets, a PE may contribute to attractiveness (also called “initial food appeal”) by its smell and/or to continued consumption by its smell but also by its taste and/or its aftertaste, and/or its mouth feel, and/or its texture. “Attractiveness” is an aspect of palatability that induces an animal to initially taste or try a food product, and that can be measured by the criteria “first choice” or “first food consumed”. “Continued consumption” is an aspect of palatability that induces an animal to continue consuming a food product that has been initially only tasted or tried.

It is herein meant by the term “palatability-enhancing composition” (PEC), an edible composition that is both palatable to pets and appealing to pet owners. A PEC may be natural, processed or unprocessed, synthetic, or part of natural and part of synthetic materials. A PEC may be liquid or dry. In the context of the present invention, a PEC comprises at least one dry food aroma and at least one PE as defined above. A PEC can also be designated a “sensorial solution”.

As used herein, an “aroma” comprises a single aromatic compound (referred to herein as a “flavoring”), or several flavorings. In an “aroma”, the one or more flavorings are present so as to produce the overall aroma's effect. The overall “aroma's effect” or “aroma's function” comprises: to impart a desirable odor to a food product and/or to modify the particular odor of a food product.

In the context of the present invention, the “aroma” is perceived by the olfactory sense of pet owners. It is thus regarded as the pet food product's appeal to pet owners.

Specific examples of “flavorings” may be found in the current literature (e.g. in Fenaroli's Handbook of Flavor Ingredients, 6^{th} Ed., 2010, CRC Press). “Flavorings” can be of natural or synthetic origin. Examples of flavorings include natural extracts such as citrus extracts (e.g., lemon, orange, lime, grapefruit, or mandarin oils), coffee, tea, mint, cocoa, and essential oils of herbs and spices. Other examples of “flavorings” include flavoring aromatics, oils, essential oils, oleoresins and extracts derived from plants, for example from leaves, flowers, fruits, roots, rhizomes, stem, and so forth. Yet other examples of “flavorings” are aromatics obtained by chemical synthesis.

In a typical aroma, flavorings are present in the form of a mixture with “carriers” such as “solvents”, “adjuvants”, and/or other flavoring co-ingredients, for example those of current use in the flavor and/or food industry. Generally, all these flavoring co-ingredients belong to various chemical classes such as alcohols, aldehydes, ketones, esters, ethers, acetates, nitriles, terpenoids, nitrogenous or sulphurous heterocyclic compounds, and the like.

In the context of the present invention, a “carrier” means a material which is substantially neutral from an odor or flavor point of view, insofar as it does not significantly alter the essential organoleptic properties of flavorings.

The “carrier” may be a liquid or a solid. As a liquid carrier, non-limiting examples include an emulsifying system (i.e., a “solvent” and a surfactant system) or a “solvent”. Non-limiting examples of suitable solvents include propylene glycol, triacetine, triethyl citrate, benzylic alcohol, ethanol, vegetable oils, and terpenes. As a solid carrier, non-limiting examples include absorbing gums or polymers, or encapsulating materials. Examples of such materials may comprise wall-forming and plasticizing materials, such as mono-, di- or trisaccharides, natural or modified starches, hydrocolloids, cellulose derivatives, polyvinyl acetates, polyvinylalcohols, proteins or pectins.

In particular, the flavorings may be liquid at 40° C., more preferably at 30° C., and yet more preferably at ambient temperature, at 1 atmosphere. When the flavorings are solid, a “solvent” is commonly used to provide an aroma under a liquid form, or under a dry form if the solvent/flavoring mixture is further appropriately dried.

In the context of the present invention, an “adjuvant” means an ingredient capable of imparting to an aroma (e.g., a carrier/flavoring mixture) an additional benefit such as color, a particular light resistance, chemical stability, and so on. Appropriate adjuvants that are commonly used in aroma synthesis are well known to a person skilled in the art.

The terms “aroma”, “flavour”, “fragrance”, and “scent” are herein considered as absolute equivalents.

By “food aroma”, it is meant herein an edible aroma that can be consumed by an animal. Particular aromas can also be consumed by humans. Examples of suitable food aromas are, without limitation, Maillard reaction products, edible aromas obtained by chemical synthesis or by fermentation, and the like.

As used herein, the terms “dry food aroma” refer to an aroma having a water content of less than or equal to about 10%, preferably from about 1 to about 8%, by weight based on the total weight of the dry food aroma, for use in food, in particular in animal food. In particular dry food aromas can be under a powder form.

A “dry food aroma” can be prepared by conventional methods in the art so as to remove any excess water. Such methods use common drying devices such as rotary dryers, fluidized bed dryers, tunnel dryers, cylinder dryers, spray-dryers, and the like. A particular example of a drying method comprises combining the food aroma to be dried with carriers for drying in appropriate proportions, and by blending the components. The mixture is then dried by evaporation at an appropriate temperature so as to obtain a dry food aroma.

Alternatively, a “dry food aroma” can be prepared by conventional methods in the art enabling to provide stable solid adsorbate complexes which uniformly incorporate a liquid food aroma. “Adsorption” is a standard technique for fixing an aroma onto a carrier for drying, in particular by chemical bonding or intramolecular forces, for instance by spraying a liquid food aroma onto a powder carrier for drying.

Yet alternatively, a “dry food aroma” can be prepared by encapsulation. “Encapsulation” is a well-known process to a person skilled in the art, and may be performed, for instance, using techniques such as spray-drying, agglomeration, extrusion, coacervation, and the like.

As used herein, the terms “carrier for drying” encompass conventional compounds that are well-known in the art. Examples thereof are microbial proteins (e.g., yeasts), animal proteins, vegetable proteins, carbohydrates (e.g., maltodextrin, cyclodextrin), as well as minerals or inorganic compounds, including inorganic phosphate compounds as defined herein. Some “carriers for drying” may also be used as carriers for encapsulation (in particular, cyclodextrin).

The term “animal” is used in a general sense and means a human or other animal that may choose a food product based upon its palatability and/or attractiveness, including avian, bovine, canine, equine, feline, lupine, murine, ovine, and porcine animals, thus encompassing pets.

The present invention preferably concerns food products for pets.

The terms “pet” and “companion animal” are synonymous and mean any domesticated animal including, without limitation, cats, dogs, rabbits, guinea pigs, ferrets, hamsters, mice, gerbils, birds, horses, cows, goats, sheep, donkeys, pigs, and the like.

In the context of the present invention, pets such as dogs and cats are preferred. However, although the present disclosure is focused on dogs and cats, the invention can be adapted for use with other classes of companion animals. If desired, the invention can be tested to evaluate its suitability for use with different classes of animals that may be considered as companion animals.

The term “appeal” can be regarded as a synonymous of the expression “pleasant smell” or “high degree of acceptance”. From the pet owner's point of view, the compositions and methods provided herein allow to block bad or unpleasant or offensive smells (such as off-odors, malodours, very or too intense odors, etc.) of pet food products. Advantageously, the compositions and methods provided herein further allow conferring a smell to pet food products that is pleasant for the pet owner.

The term “appealing” is used herein to qualify an odor that is attractive or desirable for the pet owner. It is meant that the perceived smell of the pet food product by the owner is without negative odor attributes (no offensive or disgusting or undesirable odors), but that it has odor attributes associated to pleasant and/or desirable and/or engaging feelings in humans. Advantageously, the appealing effect of the pet food product in accordance with the present invention is sustained over time. In particular, said appealing effect is sustained at least over 3 months, more particularly at least over 6 months, yet more particularly at least over 9 months, and even more particularly at least over 12 months.

Appropriate methods for appeal assessing are disclosed in the Examples below. In particular, human panels, such as human trained panels and/or human pet owner panels, can be used.

The term “pet owner”, as used herein, means a person who owns a pet; and/or takes care of him, including buying pet foods and/or feeding the pet, and that has some expectations toward foods that he gives to his animal.

The expression “human trained panel”, as used herein, means a group of persons trained to realize sensorial analyses related to one or more of PEs, PECs and pet food products. Such a panel has the knowledge of the products to be tested and of the sensorial methods to be used.

“Human pet owner panels” or “human naïve pet owner panels” are typically used to evaluate a level of pet owner acceptance of a food product prior to its introduction in the market. The pet owner test serves as a “technical measure” of how a prototype product would actually perform if introduced into the market. Since the pet owner, and not the animal, is the one who makes the direct decision to purchase a pet food product, an evaluation by a human naïve pet owner panel is of interest to determine the perception by pet owners of the odor of the pet food product.

The terms “increased or improved pet owner appeal of a pet food product in comparison with said pet food product which does not comprise said dry food aroma” refer to a better or higher pet owner appealing effect of a pet food product compared to said pet food product which does not comprise said dry food aroma. Such an “increased or improved pet owner appeal of a pet food product” is typically shown by comparative assays, as described in the Examples below.

The terms “at least maintained palatability of a pet food product in comparison with said pet food product which does not comprise said dry food aroma”, or “pet food product having at least a maintained palatability for pets in comparison with said pet food product which does not comprise said dry food aroma”, as used herein, mean that the palatability of the pet food product is not decreased, being either equivalent or enhanced, compared to the palatability of said pet food product which does not comprise said dry food aroma.

The terms “said pet food product which does not comprise said dry food aroma” refer to the same pet food product, which only differs by the fact that it does not comprise said dry food aroma.

The terms “said pet food product which comprises said food aroma in its liquid form” refer to the same pet food product, which only differs by the fact that it comprises said food aroma in its liquid form (instead of its dry form).

The term “food” or “food product” as used herein means a product or composition that is intended for ingestion by an animal and provides at least one nutrient to the animal. The term “food” includes any food, feed, snack, food supplement, treat, toy (chewable and/or consumable toys), meal substitute, or meal replacement.

The term “pet food” or “pet food product” means a composition intended for consumption by a pet.

There are three main categories or classes of pet food products depending on their moisture content, which is either low or medium or high:
dry or low moisture-containing products (having less than about 15% moisture): they usually produce a crunching sound when chewed by a pet; they are generally highly nutritious, may be inexpensively packaged (e.g., in bags or boxes), and are highly convenient to store and use;
canned or wet or high moisture-containing products (having more than about 50% moisture): typically high meat-containing products, they are usually costly to produce and package (mainly in cans);
semi-moist or semi-dry or soft dry or soft moist or intermediate or medium moisture-containing products (having from about 15 to about 50% moisture): usually packaged in appropriate bags or boxes,

Of note, only dry and semi-moist pet food products are concerned by the present invention.

Nutritionally-balanced pet foods are widely known and used in the art.

A “nutritionally-complete”, “nutritionally-balanced” or “complete” or “complete and nutritionally-balanced food” is one that contains all known required nutrients for the intended recipient of the food product, in appropriate amounts and proportions based, for example, on recommendations of recognized or competent authorities in the field of companion animal nutrition. Such foods are therefore capable of serving as a sole source of dietary intake to maintain life, without the addition of supplemental nutritional sources.

The term “kibble” used herein refers to particulate chunks or pieces formed by either a pelleting or extrusion process. Typically, kibbles are produced to give dry and semi-moist pet food. The pieces can vary in sizes and shapes, depending on the process or the equipment. For instance, kibbles can have spherical, cylindrical, oval, or similar shapes. They can have a largest dimension of less than about 2 cm for example.

The term “food supplement” or “dietary supplement” or “supplement” means a product that is intended to be ingested in addition to the normal animal diet. Dietary supplements may be in any form, e.g., solid, liquid, gel, tablets, capsules, powder, and the like. However, only dry and semi-moist food supplements are concerned by the present invention. Preferably they are provided in convenient dosage forms. In some embodiments, they are provided in bulk consumer packages such as bulk powders. In other embodiments, supplements are provided in bulk quantities to be included in other food items such as snacks, treats, supplement bars, and the like. PECs can be used to improve palatability of dietary supplements in the same manner as they are used to improve palatability of nutritionally-balanced foods.

The term “treat” (or “biscuit”) means any food item that is designed to be fed to a pet, preferably at non-meal time, by the owner to help, promote or sustain a bonding process between a pet and its owner. Examples of treats for dogs are bones. Treats may be nutritional or not. Treats can contain PECs in a manner comparable to nutritionally-balanced foods.

“Toys” include, for example chewable toys. Examples of toys for dogs are artificial bones. Toys further include partially consumable toys (e.g., comprising plastic components) or fully consumable toys (e.g., rawhides).

As used herein, a “pet food preparation” is any compound, composition or material that is used for preparing food products for pet consumption, i.e. pet food products. Non-limiting examples of pet food preparation include one or more ingredients chosen from the group of: PEs, animal digests, nitrogen compounds (e.g., proteins, peptides, and amino acids), carbohydrates, fats or lipids, nutrients, preservatives including anti-oxidants, surfactants, texturing or texturizing or stabilizing agents, colouring agents, inorganic phosphate compounds, etc. Such ingredients may be comprised as such in the pet food preparation, or they can be contacted into the preparation and react in situ for producing transformed materials that are also encompassed in the group of ingredients of a “pet food preparation”. Examples of ingredients that react together in the preparation are, without limitation, nitrogen compounds and carbohydrates, so as to obtain transformed materials such as Maillard reaction products, and the like.

“Proteins” or “polypeptides” include all conventional protein sources that are compatible for animal consumption, especially plant or vegetable proteins, animal proteins, and microbial proteins (e.g., yeast).

Examples of animal proteins are casein, albumin, animal digests, poultry meal, meat meal, bone meal, fish meal, and the like.

Examples of vegetable proteins are corn gluten, soy protein, soy flour, hydrolyzed vegetable protein (HVP), and the like.

The term “yeast” herein refers to any yeast, preferably inactive, as well as to yeast by-products that are compatible with compositions for animal consumption. Yeasts are well known in the art as being protein-rich. Yeasts include, without limitation, brewer's yeast, baker's yeast, torula yeast, molasses yeast, and the like. Yeast by-products include, without limitation, yeast extracts, yeast hydrolysates, yeast autolysates, etc.

The term “amino acid” means a molecule containing both an amino group and a carboxyl group. In some embodiments, the amino acids are α-, β-, γ- or δ-amino acids, including their stereoisomers and racemates.

As used herein, the terms “nitrogen compound” encompass the twenty known natural amino acids, as well as amino acid sequences, i.e., peptides, oligopeptides, and proteins or polypeptides. Also are included all compounds containing nitrogen from any sources that are acceptable for use in pet foods. Appropriate nitrogen compounds can be chosen from any nitrogen compounds containing sulfur that are acceptable for use in pet foods, such as sulfur-containing amino acids (e.g., methionine, cystine, cysteine), glutathione; other amino acids such as glycine, alanine, glutamic acid, and the like; as well as other compounds such as HVPs, yeast autolysates, yeast extracts, yeast hydrolysates; and combinations thereof.

Examples of carbohydrates include dextrose, fructose, sucrose, polysaccharides, fibers, starches, and the like. Preferably, carbohydrates are or contain reducing sugars.

Preferably, “reducing sugars” are chosen from hexoses, pentoses, glucose, fructose, xylose, ribose, arabinose, starch hydrolysates, and the like, as well as combinations thereof.

Examples of fats include tallow, oils, from any origin such as animal, plant (including vegetable), or marine oils. Plant oils which are available in large quantities are typically canola oil, soybean oil, corn oil, olive oil, sunflower oil, linseed oil, palm oil, safflower oil, and the like, as well as by-products thereof. Typical animal fats are tallow, lard, poultry fat, and the like, as well as by-products thereof. Marine oils are typically tuna oil, sardine oil, salmon oil, anchovy oil, fish oil, and the like, as well as by-products thereof. Also are encompassed herein the fats that are derived from animal, plant, marine sources, or that are produced by animals and plants.

Examples of nutrients include, without limitation, vitamins, minerals and electrolytes, such as vitamins A, C, E, B12, D3, folic acid, D-biotin, cyanocobalamin, niacinamide, thiamine, riboflavin, pyridoxine, menadione, beta-carotene, calcium pantothenate, choline, inositol, calcium, potassium, sodium, zinc, iron, manganese, copper, iodine, and the like.

“Preservatives” are in particular used for ensuring a long shelf life of a food product or a food composition. Preservatives comprise natural or synthetic anti-oxidants (such as BHA, BHT, propyl gallate, octyl gallate, tocopherols, rosemary extracts, and the like); as well as sorbic acid or sorbic salts (e.g., potassium sorbate), and other acids like phosphoric acid and the like. “Surfactants” are molecules that are surface active. They typically have a hydrophilic portion (e.g., one or more head groups) and a hydrophobic (or lipophilic) portion (e.g., one or more tails). They are classified in various ways, for example according to their hydrophilic-lipophilic balance (HLB). They can also or alternatively be classified as non-ionic, ionic or zwitterionic compounds based on the presence or absence of formally-charged in the head group(s). Surfactants are well-known in the art. One can cite, for example, Tween® surfactants. Surfactants include, without limitation, emulsifiers and wetting agents. In some instances, the terms “surfactants” and “emulsifiers” can be used interchangeably.

The term “inorganic phosphate compound” as used herein means a chemical compound comprising at least one phosphorus atom. This chemical compound may be natural or synthetic, ionized or not. Examples of inorganic phosphate compounds include polyphosphates, pyrophosphates, and monophosphates.

“Inorganic pyrophosphates” or “pyrophosphates” include alkali metal pyrophosphates, encompassing monoalkali metal pyrophosphates and polyalkali metal pyrophosphates.

Examples of pyrophosphates include, without limitation, sodium trihydrogen pyrophosphate, potassium trihydrogen pyrophosphate, disodium dihydrogen pyrophosphate, dipotassium dihydrogen pyrophosphate, trisodium hydrogen pyrophosphate, tripotassium hydrogen pyrophosphate, tetrasodium pyrophosphate, and tetrapotassium pyrophosphate.

Non-limiting examples of polyphosphates are tripolyphosphates, pentapolyphosphates, and hexapolyphosphates.

Examples of monophosphates include, without limitation, monosodium monophosphate, disodium monophosphate, trisodium monophosphate, monopotassium monophosphate, dipotassium monophosphate, tripotassium monophosphate, guanosine monophosphate (GMP), and inosine monophosphate (IMP).

A “texturing agent” or “texturizing agent” or “stabilizing agent” is an ingredient that affects the texture or the mouth feel of an edible product, e.g., a component that increases the viscosity of an edible product.

A “colouring agent” means herein any substance of natural origin or any synthetic colour that is suitable (preferably certified) for use in pet food. Colouring agents are useful to, inter alia, compensate for colour changes during processing or to give an appetizing colour to an edible product.

A “thermal reaction” is, according to the present invention, a reaction obtained by combining at an elevated temperature, at least one carbohydrate, preferably a reducing sugar, and at least one nitrogen compound. Such a reaction may actually include various concomitant and/or successive reactions, including, e.g., Maillard reaction(s).

It is thus meant herein by the term “Maillard ingredient(s)” or “Maillard precursor(s)”, one or more carbohydrates, preferably reducing sugars; and/or one or more nitrogen compounds. Indeed, Maillard ingredients are ingredients used to achieve one or more thermal reactions as defined above.

A “Maillard reaction product” means herein any compound produced by a Maillard reaction. In particular, a Maillard reaction product is a compound that provides flavour and/or color and/or odor and/or taste and/or aftertaste.

“Coating”, as used herein, refers to the topical deposition of the palatability-enhancing composition onto the surface of the basal food product or of a pet food product preparation, such as by spraying, dusting, and the like.

“Inclusion” as used herein, refers to the addition of the palatability-enhancing composition internally to the pet food preparation, by mixing it with other pet food ingredients, before further processing steps for obtaining the final pet food product.

The term “single package” means that the components of a kit are physically associated in or with one or more containers and considered a unit for manufacture, distribution, sale, or use. Containers include, but are not limited to, bags, boxes, cartons, bottles, pouches, packages of any type or design or material, over-wrap, shrink-wrap, stapled or otherwise affixed components, or combinations thereof. A single package may be containers of individual components physically associated such that they are considered a unit for manufacture, distribution, sale, or use.

As used herein, a “means for communicating information or instructions” is a kit component under any form suitable for providing information, instructions, recommendations, and/or warranties, etc. Such a means can comprise a document, digital storage media, optical storage media, audio presentation, visual display containing information. The means of communication can be a displayed web site, brochure, product label, package insert, advertisement, visual display, etc.

### DESCRIPTION OF THE INVENTION

It is shown herein that a palatability-enhancing composition comprising or consisting of at least one dry food aroma and at least one pet food palatability enhancer (PE) in a pet food product enables to improve appeal to pet owners while at least maintaining palatability to pets of said pet food product, in comparison with said pet food product which does not comprise said dry food aroma (i.e. in comparison with the same pet food product, which only differs by the fact that it does not comprise said dry food aroma), in particular in comparison with said pet food product which comprises said food aroma in its liquid form.

Particularly, the Inventors have surprisingly observed that combining a dry food aroma (as a powder) with a PE, enables to produce a pet food product (FP) having a better effect on appeal to pet owners than the effect observed upon combining the same food aroma under its liquid form with said PE, while a satisfying palatability to pets was at least maintained.

Thus, in one aspect, the invention relates to the use of a palatability-enhancing composition comprising or consisting of at least one dry food aroma and at least one pet food palatability enhancer in a pet food product, for improving appeal to pet owners while at least maintaining palatability to pets of said pet food product, in comparison with said pet food product which does not comprise said dry food aroma, in particular in comparison with said pet food product which comprises said food aroma in its liquid form.

Advantageously, said pet food product exhibits a sustained improved appeal to pet owners while at least a maintained palatability to pets (in comparison with said pet food product which does not comprise said dry food aroma) over time, in particular at least over 3 months, more particularly at least over 6 months, yet more particularly at least over 9 months, and even more particularly at least over 12 months.

Said PEC is preferably obtained by combining said dry food aroma with said PE. Such a combination indeed allows to (“technical effects of the combination”): (i) promote sensorial interactions between the dry aroma and the liquid or dry PE, and/or between the dry aroma and one or more other PEC's ingredients, and/or between the liquid or dry PE and one or more other PEC's ingredients; and (ii) achieve homogeneity of the PEC. In this respect, this combination is not only a physical, structural combination of two or more components (i.e., the dry aroma and the liquid or dry PE and, optionally, one or more other PEC's ingredients), but also an active, functional combination of said components so that the foregoing unexpected and advantageous technical effects of the combination are observed.

To do so, the skilled artisan will in particular consider the PE's physical characteristics in light of his general knowledge. If necessary, he will perform standard routine work to find out the appropriate conditions of time, temperature, and stirring for achieving a suitable combination.

PE's physical characteristics are, e.g., the PE's viscosity and/or density and/or flowability when liquid; the density and/or flowability and/or particle size and/or dustiness when the PE is dry.

For instance, the combination can be performed by incorporating said aroma during the process for manufacturing the PE, preferably at a late stage of said manufacturing process, e.g., once all the successive steps of addition of PE's ingredients have been performed. Alternatively, the combination can be realized once the PE is manufactured, either immediately at the end of its manufacturing process or after storage of the PE. Here again, the combination will be adapted so that sensorial interactions between at least the dry aroma and the liquid or dry PE are promoted, and the resulting PEC is homogeneous.

Dry food aromas can be chosen from the group consisting of animal dry aromas, vegetable dry aromas and dairy dry aromas.

As used herein, the term “animal dry aromas” refers to dry aromas conferring to a product, in particular to a pet food product, a smell and/or an olfactive profile evocating animal products and/or containing edible animal products.

Animal dry aromas can be chosen from the group consisting of:
beef dry aromas including roasted beef dry aromas, grilled meat dry aromas, beef meat dry aromas, cooked meat dry aromas (bolognese, strogonoff), stewed beef dry aromas;
poultry dry aromas including chicken dry aromas (grilled, boiled, meat, dark, cooked), duck dry aromas (grilled, boiled, meat, dark, cooked), turkey dry aromas (grilled, boiled, meat, dark, cooked), goose dry aromas (grilled, boiled, meat, dark, cooked), in particular chicken dry aromas (grilled, boiled, meat, dark, cooked);
pork dry aromas including bacon dry aromas, Parma ham dry aromas; and

marine dry aromas including fish dry aromas (like white fish, salmon, tuna, bonito aromas), crustacean dry aromas (like crab);

in particular beef dry aromas and poultry dry aromas and more particularly beef dry aromas and chicken dry aromas (grilled, boiled, meat, dark, cooked).

As used herein the term “vegetable dry aromas” means dry aromas conferring to a product, in particular to a pet food product, a smell and/or an olfactive profile evocating vegetable products and/or containing edible vegetable products.

Vegetable dry aromas can be chosen from the group consisting of:
herbs dry aromas, in particular including at least one, particularly at least two of the herbs dry aromas chosen in the group consisting of laurel dry aromas, basil dry aromas, rosemary dry aromas, thym dry aromas, oregano dry aromas, tarragon dry aromas, dill dry aromas and sage dry aromas; and

fruits and vegetables dry aromas, including cooked and/or processed vegetables dry aromas (like onion dry aromas, tomato dry aromas, garlic dry aromas, carrot dry aromas, cocoa dry aromas), fresh/raw vegetables dry aromas (like tomato dry aromas, coconut dry aromas); in particular herbs dry aromas.

As used herein, the term dairy dry aromas relates to dry aromas conferring to a product, in particular to a pet food product, a smell and/or an olfactive profile evocating dairy products and/or containing edible dairy products.

Dairy dry aromas can be chosen from the group consisting of:
butter dry aromas (fresh, cooked);
milk dry aromas (fresh, condensed);
cheese dry aromas (fresh, creamy, soft cheese, processed cheese, goat cheese);
in particular butter dry aromas.

Pet food palatability enhancers can be chosen from the group consisting of animal palatability enhancers and vegetarian palatability enhancers.

In particular, pet food palatability enhancers are formulated and/or processed according to the pet species. Appropriate methods for formulating and/or processing pet food palatability enhancers according to the pet species are well known by one skilled in the art.

As used herein, the term “animal palatability enhancer” relates to any material comprising an animal digest, an animal fat and/or a dairy product.

Animal palatability enhancers can be chosen from the group consisting of animal digests, animal fats and dairy products, in particular animal digests.

The term “animal digest” relates to any material which results from chemical and/or enzymatic hydrolysis of clean, undecomposed animal tissue. In some embodiments, an animal digest as used herein is fully consistent with the definition promulgated by the Association Of American Feed Control Officials, Inc. (AAFCO). Animal digest is preferably derived from animal tissues as well as fish tissues, excluding hair, horns, teeth, hooves, and feathers. The skilled artisan will appreciate that while such tissues are not preferred, trace amounts might be found unavoidably even under good manufacturing practices. Also not included are visceral contents or foreign or fecal matter, although trace contaminant amounts are sometimes present. An animal digest may be dried or not. Typically, examples of animal digests are:
digest of poultry (or pork, beef, sheep, lamb, fish, etc.): material from poultry (pork, beef, etc.) which results from chemical and/or enzymatic hydrolysis of clean and undecomposed tissue;
digest of pork (or beef, sheep, lamb, etc.) by-products: material from pork (beef, etc.) which results from chemical and/or enzymatic hydrolysis of clean and undecomposed tissue from non-rendered clean parts from cattle (pigs, sheep, lamb, etc.), other than meat and bones, for example lungs, spleen, kidneys, brain, livers, blood, optionally partially-defatted low-temperature fatty tissue, and stomachs and intestines, freed of their contents;
digest of poultry by-products: material which results from chemical and/or enzymatic hydrolysis of clean and undecomposed tissue from non-rendered clean parts of poultry, other than meat and bones, such as livers, hearts, heads, feet, and viscera. As used herein, “poultry” encompasses any species or kind of bird, preferably chicken, turkey, duck, and the like; and
digest of fish by-products: material which results from chemical and/or enzymatic hydrolysis of clean and undecomposed tissue from non-rendered clean parts from fish. As used herein, “fish” encompasses any species or kind of fish or crustaceans or molluscs, preferably tuna, salmon, cod, hake, sardine, shrimp, squid, and the like.

In particular, animal digests can be chosen from the group consisting of poultry digests, pork digests, beef digests, sheep digests, lamb digests, fish digests, pork by-products digests, beef by-products digests, sheep by-products digests, lamb by-products digests, poultry by-products digests, fish by-products digests, more particularly in the group consisting of poultry digests, pork digests and fish digests.

Animal fats include tallow, lard, poultry fat, and the like, and by-products thereof, marine oils like tuna oil, sardine oil, salmon oil, anchovy oil, fish oil, and the like, and by-products thereof. Also are encompassed herein the fats that are derived from animal or produced by animals

As used herein the term “dairy products” refers to any material composed and/or produced from milk of mammals.

Dairy products include milks and milk derivatives in a liquid, condensed or dry form. Dairy products can be whole milks or partially skimmed milks, and derivatives like: whey, creams, buttermilk, fermented milks like cheeses, yogurts, quark, cottage cheese, ethnic preparations like Ghee, khoa, kefir and the like, Milk protein concentrates and isolates, Whey protein concentrates and isolates, milks extracts like caseinates, caseinates salts, lactoserum, and the like.

The term <<vegetarian palatability enhancer>> means herein materials free of meat or animal products, and derived from or isolated from plant, bacterial, fungal or algal sources, or single compounds not obtained from animal sources. Vegetarian palatability enhancer can be dry or liquid. For example, a vegetarian palatability enhancer can include:
Inactivated yeasts and yeast derivatives such as yeast autolysates, yeast extracts
Vegetable or grain materials and derivatives, like soya and soya based materials such as soya concentrates and soya isolates, hydrolyzed vegetable proteins “HVP”, corn and corn based materials like corn grain meal, corn aerian part meals, corn steep syrups, wheat and wheat based materials, potatoe meal, pea meals, tapioca, starches, modified starches
Plant oils such as canola oil, soybean oil, corn oil, olive oil, sunflower oil, linseed oil, palm oil, safflower oil, and the like, and by-products thereof,
non animal originating fermented products,
algal and algal derivatives
organic or mineral molecules or compounds that would not be originating from animals, and obtained through chemical, biochemical process. As examples, sugars, salts, amino acids obtained by fermentation or extraction from non animal materials, and the like.

In one embodiment, said palatability-enhancing composition comprises from 0.25 to 20%, particularly from 0.5 to 15%, more particularly from 1 to 10% and even more particularly from 1 to 5% by weight of said dry food aroma based on the total weight of said composition.

Said palatability-enhancing composition can comprise from 80 to 99.75%, particularly from 85 to 99.5%, more particularly from 90 to 99% and even more particularly from 95 to 99% by weight of said pet food palatability enhancer based on the total weight of said composition.

The weight ratio of said dry food aroma to said pet food palatability enhancer can be from 0.25:99.75 to 20:80, particularly from 0.5:99.5 to 15:85, more particularly from 1:99 to 10:90 and even more particularly from 1:95 to 5:99.

Said pet food product can comprise from 0.25 to 12%, particularly from 0.5 to 8% and more particularly from 0.5 to 5% by weight of said palatability-enhancing composition based on the total weight of said pet food product.

Another aspect of the present invention concerns the use of a palatability-enhancing composition (PEC) comprising at least one dry food aroma and at least one PE for preparing a FP, said FP having an increased (improved) appeal to pet owners while at least a maintained palatability to pets, in comparison with said pet food product which does not comprise said dry food aroma, in particular in comparison with said pet food product which comprises said food aroma in its liquid form.

Another aspect of the present invention relates to a PEC comprising at least one dry food aroma and at least one pet food PE, as an intermediate product for preparing a pet food product having an increased (improved) appeal to pet owners while at least a maintained palatability to pets, in comparison with said pet food product which does not comprise said dry food aroma, in particular in comparison with said pet food product which comprises said food aroma in its liquid form.

The PECs of the present invention are useful in pet foods such as nutritionally-balanced mixtures containing appropriate pet food ingredients including proteins, fibre, carbohydrates and/or starch, etc. Such mixtures are well known to those skilled in the art, and their composition depends on many factors such as, for example, the desired food balance for the specific type of pet. Additional pet food ingredients may include other PEs, vitamins, minerals, seasonings, preservatives, and surfactants. The food balance, including the relative proportions of vitamins, minerals, lipids, proteins and carbohydrates, is determined according to the known dietary standards in the veterinary field, for example by following recommendations of the National Research council (NRC), or the guidelines of the American Association of Feed Control Officials (AAFCO).

Yet another aspect of the present invention is directed to a method for preparing a pet food product having an increased (improved) appeal to pet owners while at least a maintained palatability to pets, in comparison with said pet food product which does not comprise said dry food aroma, comprising adding a PEC as described herein, to a pet food preparation.

The invention also relates to a method for preparing a pet food product comprising the step(s) of:
combining at least one dry food aroma to at least one pet food palatability enhancer to obtain a palatability-enhancing composition; and
adding, in particular by coating, said palatability-enhancing composition to a pet food product preparation to obtain a pet food product;
   wherein said pet food product has an improved appeal to pet owners while at least a maintained palatability to pets, in comparison with said pet food product which does not comprise said dry food aroma, in particular in comparison with said pet food product which comprises said food aroma in its liquid form.

The advantageous embodiments are as defined above.

Dry pet food products such as kibbles can commonly be prepared by different methods. One of these methods, that is widely used, is a cooker-extruder method. In the cooker-extruder method, ingredients are first blended together to form an admixture. This admixture is transferred into a steam conditioner where it is sufficiently moistened to become extrudable. The admixture then enters a cooker-extruder where it is cooked at an elevated temperature and pressure and then forced out of the apparatus through a die. This die forms the extruder product into a specific shape. Individual pieces of food are created by periodically slicing off the end of the extruded stream of product. The individual pieces are then dried in a hot air dryer. Generally, the product is dried until it contains less than 15% moisture, and preferably about 4 to 10% moisture. The dried particles or pieces are then transferred by bulk conveyor to a coating drum and sprayed with fat. Other liquids, such as, for example, phosphoric acid may alternatively be applied to the pieces, or applied in addition to the fat. The resulting pellets or kibbles constitute the basal pet food preparation, the palatability of which will be enhanced using the PECs of the present invention.

PECs can be added, applied, to the pet food either by coating or by inclusion. In the context of the present invention, PECs are preferably added, applied, by coating.

For example, one can cite a method for coating dry pet foods such as kibbles. Kibbles of uncoated, extruded basal pet food can be placed in a container such a tub or a coating drum for mixing. A fat, such as pork fat or poultry fat, is heated and then sprayed onto the pet food in a manner to obtain a coating of the kibbles. The coating need not be a continuous layer, but preferably is uniform. After the fat, a PEC may be applied as either a liquid or a powder, while the product is mixing. A liquid PEC is typically sprayed on while a dry PEC is typically dusted on. Alternatively, PECs can be mixed with the fat and applied concurrently. Yet alternatively, PECs are coated before deposition of fat.

Alternatively, PECs can be incorporated or included into the pet food preparation according to the following illustrative method. The PEC is contacted with the raw ingredients of the pet food preparation prior to cooking. In this case, the PEC is combined to proteins, fibre, carbohydrates and/or starch, etc., of the basal food preparation and is cooked with those materials in the cooker-extruder.

The invention also relates to a method for improving appeal to pet owners while at least maintaining palatability to pets of a pet food product, comprising the step(s) of:
combining at least one dry food aroma to at least one pet food palatability enhancer to obtain a palatability-enhancing composition; and
adding, in particular by coating, said palatability-enhancing composition to a pet food product preparation to obtain said pet food product;
   in comparison with said pet food product which does not comprise said dry food aroma, in particular in comparison with said pet food product which comprises said food aroma in its liquid form.

The advantageous embodiments are as defined above.

Yet another aspect of the present invention concerns a pet food product having an increased (improved) appeal to pet owners while at least a maintained palatability to pets, in comparison with said pet food product which does not comprise said dry food aroma, in particular in comparison with said pet food product which comprises said food aroma in its liquid form, that is obtainable by a method as described above.

Still another aspect of the present invention is related to a method for preparing a PEC as disclosed herein, comprising a step of combining at least one dry food aroma with at least one PE.

A further aspect of the present invention concerns a method for feeding pets comprising at least:

a) providing a food product as disclosed above; and
b) feeding said food product to pets.

Yet a further aspect of the present invention is directed to a kit for preparing a pet food product having an increased (improved) appeal to pet owners while at least a maintained palatability to pets, comprising, in one or more containers in a single package:
at least one PEC as described above;
optionally, at least one pet food preparation;
a means for communicating information about or instructions for using said PEC and, optionally, said pet food preparation;

in comparison with said pet food product which does not comprise said dry food aroma, in particular in comparison with said pet food product which comprises said food aroma in its liquid form.

In all aspects of the present invention, said pet is preferably selected from the group consisting of cats and dogs. In particular, said pet food palatability enhancer can be a cat or a dog food palatability enhancer, said pet food product can be a cat or a dog food product, said pet owner can be a cat or a dog owner.

The present invention will be further described by reference to the following examples, which are presented for the purpose of illustration only and are not intended to limit the scope of the invention.

### EXAMPLES

### A—Method of Palatability Assessment: The “Two-Bowl” Test

A-1—Principle of the Two-Bowl Test:

The test is based on the postulate whereby the more food consumed, the more palatable it is.

Individual versus (Two bowls) appetence tests, based on the comparison between two foods, were carried out. Tests are performed either on panel of 36 dogs or on panel of 40 cats, depending on the test's objectives.

A-2—Operating Method of the Test:
Identical amounts of food product A and food product B were weighed out and placed in identical bowls. The amount present in each ration enables the daily requirements to be met.
Distribution of the bowls:

Dog test: the bowls were placed in an individual feed trough accessible to dogs.

Cat test: The bowls were presented at the same time to each cat in an individual loose box and their positions were switched at each meal to avoid a choice led by handedness.
Duration of the test:
Cat test for dry or semi dry food: from about 15 minutes to about 20 hours (if one of the two bowls was entirely eaten before the end of the test, the two bowls were removed, and the test was stopped);
Dog test for dry or semi dry food: from about 15 minutes to about 30 minutes (if one of the two bowls was entirely eaten before the end of the test, the two bowls were removed, and the test was stopped). Parameters studied
Measured parameters: First food consumed (“attractiveness”) and amount of each food consumed by the end of the test;
Calculated parameters: individual consumption ratio in % (CR)

CR_{A}=consumption of A (g)×100/(consumption of A+B) (g)

CR_{B}=consumption of B (g)×100/(consumption of A+B) (g);
Average consumption ratio (ACR)=average of all individual ratios (an equal importance is given to each animal, regardless of its size and of its corresponding consumption).

If animals have higher or lower consumption compared to predetermined values (which are function of, e.g., the animal weight and/or metabolism), they are not taken into account into statistical treatment.

A-3—Statistical Analysis:

Statistical analysis was used to determine if there was a significant difference between the 2 ratios. A Student's t-test with 3 error thresholds, namely 5%, 1% and 0.1%, was performed.

A Chi-square test was used to determine if there was a significant difference between the number of pets with Food A as first food eaten and the number of pets with Food B as first food eaten.

Significance levels are noted as below:

| | | |
|---|---|---|
| NS | not significant | (p > 0.05) |
| * | significant | (p ≦ 0.05) |
| ** | highly significant | (p ≦ 0.01) |
| *** | very highly significant | (p ≦ 0.001) |

The Examples below illustrate the effect on both palatability to pets and appeal to pet owners of food products prepared using palatability-enhancing compositions comprising (i) a food aroma, liquid or dry, and (ii) a pet food palatability enhancer, liquid or dry.

### B—Examples

The examples below report palatability assessments and human sensory (appeal) assessments of different pet food products (FP), coated with various palatability-enhancing compositions (PECs), obtained with different aromas (flavors) and different palatability enhancers (PEs), those PECs being applied on various pet food product preparations (base diets).

| | | Pet Food | | | palatability- | | |
|---|---|---|---|---|---|---|---|
| | | Product | | Palatability | enhancing | | Food |
| | | Preparation | Aroma | enhancer | compositions | | product |
| Example | Animal | (Base diet) | (Flavor) | (PE) | (PEC) | Coating | (FP) |
| 1 | DOG | Dog Diet A | Chicken | PE 1 (liquid | PEC 1A-PEC | Only | FP1A- |
| | | | 1 (A: | pork liver | 1B | liquid | FP1B |
| | | | liquid-B: | digest for | | PEC 1A | |
| | | | powder) | dog) | | or PEC | |
| | | | | | | 1B | |
| 2 | DOG | Dog Diet B | Chicken | PE 1 (liquid | PEC 2A-PEC | Only | FP2A- |
| | | | 2 (A: | pork liver | 2B | liquid | FP2B |
| | | | liquid-B: | digest for | | PEC 2A | |
| | | | powder) | dog) | | or PEC | |
| | | | | | | 2B | |
| 3 | CAT | Cat Diet B | Mixed | PE 3 (dry | PEC 3B | Only | FP3B |
| | | | herb 3B | pork liver | | powder | |
| | | | powder | digest for | | PEC 3B | |
| | | | | cat) | | | |
| 4 | CAT | Cat Diet A | Mixed | PE 4 (liquid | PEC 4B | Combination | FP4B |
| | | | herb 4B | poultry | | liquid | |
| | | | powder | digest for | | PEC 4B + | |
| | | | | cat) | | Dry | |
| | | | | | | PE 5 | |
| | | | | | | (cat dry | |
| | | | | | | poultry | |
| | | | | | | digest) | |
| 5 | CAT | Cat Diet B | Chicken | PE 3 (dry | PEC 5B | Only | FP5B |
| | | | 5B | pork liver | | powder | |
| | | | powder | digest for | | PEC 5B | |
| | | | | cat) | | | |
| 6 | DOG | Dog Diet A | Beef 6B | PE 6 (dry | PEC 6B | Combination | FP6B |
| | | | powder | poultry | | liquid PE | |
| | | | | digest for | | 7 (dog | |
| | | | | dog) | | liquid | |
| | | | | | | poultry | |
| | | | | | | digest) + | |
| | | | | | | dry PEC | |
| | | | | | | 6B | |
| 7 | CAT | Cat Diet D | Chicken | PE 8 (dry | PEC 7B | Only | FP7B |
| | | | 7B | fish digest | | powder | |
| | | | powder | for cat) | | PEC 7B | |
| 8 | CAT | Cat Diet C | Fish 8B | PE 9 (liquid | PEC 8B | Combination | FP8B |
| | | | powder | fish digest | | liquid | |
| | | | | for cat) | | PEC 8B + | |
| | | | | | | dry PE | |
| | | | | | | 10 (cat | |
| | | | | | | dry fish | |
| | | | | | | digest) | |
| 9 | DOG | Dog Diet A | Bolognese | PE 1 (liquid | PEC 9B | Only | FP9B |
| | | | 9B | pork liver | | liquid | |
| | | | powder | digest for | | PEC 9B | |
| | | | | dog) | | | |
| 10 | CAT | Cat Diet C | Butter | PE 9 (liquid | PEC 10B | Combination | FP10B |
| | | | 10B | fish digest | | liquid | |
| | | | powder | for cat) | | PEC | |
| | | | | | | 10B + | |
| | | | | | | dry PE | |
| | | | | | | 10 (cat | |
| | | | | | | dry fish | |
| | | | | | | digest) | |
| 11 | DOG | Dog Diet A | Beef 6B | PE 10 | PEC 11B | Only | FP 11B |
| | | | powder | (powder | | powder | |
| | | | | vegetarian | | PEC | |
| | | | | palatability | | 11B | |
| | | | | enhancer | | | |
| | | | | for dog) | | | |

### B-1—Example 1

In Example 1, a chicken aroma 1 was combined under its liquid (‘Aroma 1A’) or powder form (‘aroma 1B’) with a pet food palatability enhancer (‘PE1’) in appropriate amounts to keep the same level of flavorings. Pet palatability and the human sensory perception by a trained panel were assessed.

PE1 was a liquid pork liver digest obtained by hydrolysis followed by thermal treatment in the presence of Maillard precursors. PE1 was the ‘Control digest’. The experimental palatability-enhancing compositions (‘PECs’) were obtained by combining Aroma 1A or Aroma 1B with the Control digest.

The tested PECs were as described in Table 1 below.

TABLE 1

| | | |
|---|---|---|
| Control digest | PEC 1A | PEC 1B |
| % of the total | % of the total | % of the total |
| weight | weight | weight |

| | | | |
|---|---|---|---|
| PE1 | 100 | 97 | 98 |
| Aroma 1A | 0 | 3 | 0 |
| Aroma 1B | 0 | 0 | 2 |

B-1-1—Palatability Assessment

Control digest and experimental PECs 1A and 1B were sprayed at the amount of 3% by weight of dry dog kibbles “dog diet A”, previously coated with 6% poultry fat, to obtain nutritionally-complete and palatable dog dry food products (FPs) Control, 1A and 1B. Palatability was assessed in a dog panel as described above in order to compare FP1A and FP1B to the Control FP 1 month after coating. Results of palatability expressed by relative consumption ratios (in %) are presented in Table 2 below.

TABLE 2

| | Relative | Relative | |
|---|---|---|---|
| | consumption | consumption | Statistical |
| | Control FP % | Experimental FP % | significance |
| Control FP vs | 60 | 40 | NS |
| FP1A | | | |
| Control FP vs | 50 | 50 | NS |
| FP1B | | | |

‘NS’: not significant
*: significant (p ≦ 0.05)
**: highly significant (p ≦ 0.01)
***: very highly significant (p ≦ 0.001)

As shown in Table 2, consumption of dog food products was not significantly different between Control FP and FP1A or between Control FP and FP1B, demonstrating that the use of liquid chicken aroma 1A or dry chicken aroma 1B maintained food palatability.

B-1-2—Human Sensory (Appeal) Assessment

FPs 1A and 1B, as well as the Control FP, were assessed by an internal human trained panel. The 3 food products (Control FP, FP1A and FP1B) were presented to 20 trained judges 1 month after coating.

Each panelist evaluated the 3 food products in a randomized way (Williams latin square) and scored the preference for the odor type and the odor intensity on a scale from 0 to 9 (for odor type, 0: “I don't like at all”-9: “I like it very much”; for odor intensity, 0: “not intense at all”-9: “very intense”).

Then, panelists could give a free description of the food products. To do so, the panelists could propose one or more descriptors such as chicken/poultry, roasted/grilled, cooked, fatty/fat, meat, pungent/pepper/acid, herbs, sweet, tomato sauce/bolonese, spices, oxidized, loaf/pâté, broth, etc.

Means were analyzed with mixed effect Anova (food as fixed effect and judge as random effect) associated with pair wise comparisons with a Duncan correction. Concerning the description, a so-called “Mosaic diagram” illlustrating the quotation frequency of each descriptor was realized (data not shown).

Results of the scores given by a human trained panel are presented in Table 3 below.

TABLE 3

| | Control FP | FP1A | FP1B |
|---|---|---|---|
| Odor Type | 4.54^{a} | 5.23^{ab} | 6.23^{b} |
| preference | | | |
| Odor Intensity | 5.09^{a} | 5.81^{a} | 7.04^{b} |

Means sharing same letters in superscript are not significantly different (P>0.05).

As shown in Table 3, panelists preferred the odor of FP1B, with dry chicken aroma 1B, compared to Control FP. FP1A, with liquid chicken aroma 1A, was not significantly preferred compared to the Control FP.

The odor intensity of FP1B was judged significantly higher than those of Control FP and FP1A.

To facilitate comparison between the results obtained with the free description of the Mosaic diagram, the following group of 3 descriptors was chosen: chicken/poultry+roasted/grilled+cooked (Table 4 below).

TABLE 4

| | Control | | |
|---|---|---|---|
| | FP (quotation | FP1A (quotation | FP1B (quotation |
| Descriptor | frequency) | frequency) | frequency) |
| Chicken/poultry | 2 | 6 | 9 |
| Roasted/grilled | 3 | 3 | 9 |
| Cooked | 2 | 2 | 3 |
| Total | 7 | 11 | 21 |

As shown in Table 4, FP1B, with dry chicken aroma 1B, was much more described as chicken/poultry and roasted/grilled than Control FP and FP1A, showing a better aromatic expression of the dry aroma compared to the liquid aroma, and demonstrating the higher interest of using a dry aroma than a liquid aroma.

### B-2—Example 2

In Example 2, a chicken aroma 2 (different from the chicken aroma 1 used in Example 1 above) was combined under its liquid (‘Aroma 2A’) or powder form (‘Aroma 2B’) with the same pet food palatability enhancer as in Example 1 above (‘PE1’), in appropriate amounts to keep the same level of flavorings. Pet palatability and the human sensory perception by a human naïve pet owner panel were assessed. PE1 was the ‘Control digest’.

The experimental palatability-enhancing compositions (PECs) were obtained by combining Aroma 2A or Aroma 2B with the Control digest.

The tested PECs were as described in Table 5 below.

TABLE 5

| | Control digest | PEC 2A | PEC 2B |
|---|---|---|---|
| | % of the total | % of the total | % of the total |
| | weight | weight | weight |
| PE1 | 100 | 97 | 98 |
| Aroma 2A | 0 | 3 | 0 |
| Aroma 2B | 0 | 0 | 2 |

B-2-1—Palatability Assessment

Control digest and experimental PECs 2A and 2B were sprayed at the amount of 3% by weight of dry dog kibbles “dog diet B” (different from the “dog diet A” of the example 1 by its formulation and its shape), previously coated with 6% poultry fat, to obtain nutritionally-complete and palatable dog dry food products (FPs) Control, 2A and 2B. Palatability was assessed in a dog panel as described above in order to compare FP2A and FP2B to the Control FP 1 month after coating. Results of palatability expressed by relative consumption ratios (in %) are presented in Table 6 below.

TABLE 6

| | Relative | Relative | |
|---|---|---|---|
| | consumption | consumption | Statistical |
| | Control FP % | Experimental FP % | significance |
| Control FP vs | 71 | 29 | * |
| FP2A | | | |
| Control FP vs | 54 | 46 | NS |
| FP2B | | | |

‘NS’: not significant
*: significant (p ≦ 0.05)

As shown in Table 6, consumption of FP2A was significantly lower than Control FP, but consumptions of FP2B and Control FP were not significantly different, demonstrating that, for a same chicken aroma, the dry form maintained palatability whereas the liquid form decreased palatability.

B-2-2—Human Sensory (Appeal) Assessment

FPs 2A and 2B, as well as the Control FP, were assessed by a human naïve pet owner panel of 60 panelists 1 month after coating

The 3 food products (Control FP, FP2A and FP2B) were presented to 60 panelists. Each panelist compared each experimental FP to the control FP and scored the preference for the odor type on a scale from 1 to 9 (1: “I don't like at all”-9: “I like it very much”).

Results were treated by Anova analysis. Results of the score comparison given by a human naïve pet owner panel are presented in Table 7 below.

TABLE 7

| | Odor preference | |
|---|---|---|
| | scoring | Statistical significance |
| Control FP vs FP2A | 4.9 vs 5.4 | NS |
| Control FP vs FP2B | 4.7 vs 5.6 | * |

As shown in Table 7, naïve pet owner panelists significantly preferred the odor of FP2B, with dry chicken aroma 2B, compared to the Control FP. FP2A, with liquid chicken aroma 2A, was not significantly preferred compared to the Control FP.

### B-3—Example 3

In Example 3, a mixed herbs aroma 3 was combined under its powder form (‘Aroma 3B’) with a cat dry pet food palatability enhancer (‘PE3’) in appropriate amounts. Pet palatability and the human sensory perception by a trained panel were assessed.

PE3 was a dry pork liver digest obtained by hydrolysis followed by thermal treatment in the presence of Maillard precursors, yet followed by a drying step and a mixing step with a pyrophosphate salt. PE3 was the ‘Control digest’.

The experimental palatability-enhancing composition (‘PEC’) was obtained by combining Aroma 3B with the Control digest.

The tested PEC (‘PEC3B’) was as described in Table 8 below.

TABLE 8

| | | PEC 3B |
|---|---|---|
| | Control digest | % of the total |
| | % of the total weight | weight |
| PE3 | 100 | 98.5 |
| Aroma 3B | 0 | 1.5 |

B-3-1—Palatability Assessment

Control digest and experimental PEC3B were dusted at the amount of 2% by weight of dry cat kibbles “cat diet B”, previously coated with 6% poultry fat, to obtain nutritionally-complete and palatable cat dry food products (FPs) Control and 3B. Palatability was assessed in a cat panel as described above in order to compare FP3B to the Control FP, at 3 time points: 1 month, 3 months, and 6 months after coating. Results of palatability expressed by relative consumption ratios (in %) are presented in Table 9 below.

TABLE 9

| | | |
|---|---|---|
| Relative | Relative | |
| consumption | consumption | Statistical |
| Control FP % | Experimental FP3B % | significance |

Tests 1 month after coating

| | | | |
|---|---|---|---|
| Control FP vs | 56 | 44 | NS |
| FP3B - Day 1 | | | |
| Control FP vs | 54 | 46 | NS |
| FP3B - Day 2 | | | |

Tests 3 months after coating

| | | | |
|---|---|---|---|
| Control FP vs | 51 | 49 | NS |
| FP3B - Day 1 | | | |
| Control FP vs | 50 | 50 | NS |
| FP3B - Day 2 | | | |

Tests 6 months after coating

| | | | |
|---|---|---|---|
| Control FP vs | 55 | 45 | NS |
| FP3B - Day 1 | | | |
| Control FP vs | 55 | 45 | NS |
| FP3B - Day 2 | | | |

‘NS’: not significant

As shown in Table 9, consumptions of Control FP and FP3B were not significantly different, either after 1 month, 3 months or 6 months, demonstrating that the dry aroma 3 maintained palatability of the food product.

B-3-2—Human Sensory (Appeal) Assessment

FP3B and the Control FP were assessed by an internal human trained panel. The 2 food products (Control FP, FP3B) were presented to trained judges, the panels comprising 23 to 29 judges depending on the period of assessment.

Each panelist evaluated the 2 food products in a randomized way (Williams latin square) and scored the preference for the odor type on a scale from 0 to 9 (0: “I don't like at all”-9: “I like it very much”). Means were analyzed with mixed effect Anova (food as fixed effect and judge as random effect) associated with pair wise comparisons with a Duncan correction. Results of the scores given by a human trained panel are presented in Table 10 below.

TABLE 10

| | | | Statistical |
|---|---|---|---|
| | Control FP | FP3B | significance |
| Odortype | 3.85^{a} | 6.61^{b} | ** |
| preference after | | | |
| 1 month (27 | | | |
| judges) | | | |
| Odor type | 4.79^{a} | 5.82^{b} | *** |
| preference after | | | |
| 3 months (29 | | | |
| judges) | | | |
| Odor type | 4.35^{a} | 6.21^{b} | *** |
| preference after | | | |
| 6 months (23 | | | |
| judges) | | | |
| Odor type | 3.82^{a} | 6.39^{b} | *** |
| preference after | | | |
| 13 months (23 | | | |
| judges) | | | |

Means sharing same letters in superscript are not significantly different (P>0.05).

As shown in Table 10, panelists preferred the odor of FP3B, with mixed herbs Aroma 3B, compared to the Control FP, whatever the period tested: 1 month, 3 months, 6 months and 13 months after coating.

### B-4—Example 4

In Example 4, a mixed herbs aroma 4 under its powder form (‘Aroma 4B’) was combined with a cat liquid pet food palatability enhancer (‘PE4’) in appropriate amounts. Pet palatability and the human sensory perception by a trained panel were assessed.

PE4 was a cat liquid poultry digest obtained by hydrolysis followed by thermal treatment in the presence of Maillard precursors. PE4 was the ‘Control digest’. The experimental palatability-enhancing composition (‘PEC’) was obtained by combining Aroma 4B with the Control digest.

The tested PEC (‘PEC 4B’) was as described in Table 11 below.

TABLE 11

| | | PEC 4B |
|---|---|---|
| | Control digest | % of the total |
| | % of the total weight | weight |
| PE4 | 100 | 99 |
| Aroma 4B | 0 | 1 |

B-4-1—Palatability Assessment

Control digest and experimental PEC 4B were sprayed at the amount of 3% by weight of dry cat kibbles “cat diet A” (different from the “cat diet B” of the example 3 above by its formulation and its shape), previously coated with 6% poultry fat, and then dusted with a cat dry poultry digest PE5 at the amount of 2% by weight of dry cat kibbles, to obtain nutritionally-complete and palatable cat dry food products (FPs) Control and 4B. Palatability was assessed in a cat panel as described above in order to compare FP4B to the Control FP at 1 month after coating. Results of palatability expressed by relative consumption ratios (in %) are presented in Table 12 below.

TABLE 12

| | | |
|---|---|---|
| Relative | Relative | |
| consumption | consumption | Statistical |
| Control FP % | Experimental FP4B % | significance |

Tests 1 month after coating

| | | | |
|---|---|---|---|
| Control FP vs | 60 | 40 | NS |
| FP4B - Day 1 | | | |
| Control FP vs | 52 | 48 | NS |
| FP4B - Day 2 | | | |

‘NS’: not significant

As shown in Table 12, consumptions of Control FP and FP4B were not significantly different, demonstrating that the dry aroma 4 maintained palatability of the food product.

B-4-2—Human Sensory (Appeal) Assessment

FP4B and the Control FP were assessed by an internal human trained panel. The 2 food products (Control FP, FP4B) were presented to trained judges, the panels comprising 23 to 29 judges depending on the period of assessment.

Each panelist evaluated the 2 food products in a randomized way (Williams latin square) and scored the preference for the odor type on a scale from 0 to 9 (0: “I don't like at all”-9: “I like it very much”). Means were analyzed with mixed effect Anova (food as fixed effect and judge as random effect) associated with pair wise comparisons with a Duncan correction. Results of the scores given by a human trained panel are presented in Table 13 below.

TABLE 13

| | | | Statistical |
|---|---|---|---|
| | Control FP | FP4B | significance |
| Odor type | 3.67^{a} | 7.48^{b} | ** |
| preference after | | | |
| 1 month (27 | | | |
| judges) | | | |
| Odor type | 4.68^{a} | 6.36^{b} | *** |
| preference after | | | |
| 3 months (29 | | | |
| judges) | | | |
| Odor type | 4.52^{a} | 7.65^{b} | ** |
| preference after | | | |
| 6 months (23 | | | |
| judges) | | | |
| Odor type | 4.39^{a} | 7.43^{b} | ** |
| preference after | | | |
| 13 months (23 | | | |
| judges) | | | |

Means sharing same letters in superscript are not significantly different (P>0.05).

As shown in Table 13, panelists preferred the odor of FP4B, with mixed herbs Aroma 4B, compared to the Control FP, whatever the period tested: 1 month, 3 months, 6 months and 13 months after coating.

### B-5—Example 5

In Example 5, a chicken meat aroma 5 (different from the chicken aromas 1 and 2 of examples 1 and 2) was combined under its powder form (‘Aroma 5B’) with the same cat dry pet food palatability enhancer as in Example 3 (‘PE3’) in appropriate amounts. Pet palatability and the human sensory perception by a trained panel were assessed. PE3 was the ‘Control digest’.

The experimental palatability-enhancing composition (‘PEC’) was obtained by combining Aroma 5B with the Control digest.

The tested PEC (‘PEC 5B’) was as described in Table 14 below.

TABLE 14

| | | PEC 5B |
|---|---|---|
| | Control digest | % of the total |
| | % of the total weight | weight |
| PE3 | 100 | 98.5 |
| Aroma 5B | 0 | 1.5 |

B-5-1—Palatability Assessment

Control digest and experimental PEC 5B were dusted at the amount of 2% by weight of dry cat kibbles “cat diet B”, previously coated with 6% poultry fat, to obtain nutritionally-complete and palatable cat dry food products (FPs) Control and 5B. Palatability was assessed in a cat panel as described above in order to compare FP5B to the Control FP, at 3 time points: 1 month, 3 months and 6 months after coating. Results of palatability expressed by relative consumption ratios (in %) are presented in Table 15 below.

TABLE 15

| | | |
|---|---|---|
| Relative | Relative | |
| consumption | consumption | Statistical |
| Control FP % | Experimental FP5B % | significance |

Tests 1 month after coating

| | | | |
|---|---|---|---|
| Control FP vs | 56 | 44 | NS |
| FP5B - Day 1 | | | |
| Control FP vs | 58 | 42 | NS |
| FP5B - Day 2 | | | |

Tests 3 months after coating

| | | | |
|---|---|---|---|
| Control FP vs | 51 | 49 | NS |
| FP5B - Day 1 | | | |
| Control FP vs | 48 | 52 | NS |
| FP5B - Day 2 | | | |

Tests 6 months after coating

| | | | |
|---|---|---|---|
| Control FP vs | 49 | 51 | NS |
| FP5B - Day 1 | | | |
| Control FP vs F | 59 | 41 | NS |
| FP5B - Day 2 | | | |

‘NS’: not significant

As shown in Table 15, consumptions of Control FP and FP5B were not significantly different, either after 1 month, 3 months or 6 months, demonstrating that the chicken dry aroma 5 maintained palatability of the food product.

B-5-2—Human Sensory (Appeal) Assessment

FP5B and the Control FP were assessed by an internal human trained panel. The 2 food products (Control FP, FP5B) were presented to trained judges, the panels comprising 23 to 29 judges depending on the period of assessment.

Each panelist evaluated the 2 food products in a randomized way (Williams latin square) and scored the preference for the odor type on a scale from 0 to 9 (0: “I don't like at all”-9: “I like it very much”). Means were analyzed with mixed effect Anova (food as fixed effect and judge as random effect) associated with pair wise comparisons with a Duncan correction. Results of the scores given by a human trained panel are presented in Table 16 below.

TABLE 16

| | | | Statistical |
|---|---|---|---|
| | Control FP | FP5B | significance |
| Odor type preference | 3.85^{a} | 5.96^{b} | ** |
| after 1 month (27 | | | |
| judges) | | | |
| Odor type preference | 4.79^{a} | 5.54^{b} | *** |
| after 3 months (29 | | | |
| judges) | | | |
| Odor type preference | 4.35^{a} | 6.04^{b} | * |
| after 6 months (23 | | | |
| judges) | | | |
| Odor type preference | 3.82^{a} | 6.08^{b} | ** |
| after 13 months (23 | | | |
| judges) | | | |

Means sharing same letters in superscript are not significantly different (P>0.05).

As shown in Table 16, panelists preferred the odor of FP5B, with Chicken aroma “Aroma 5B”, compared to the Control FP, whatever the period tested: 1 month, 3 months, 6 months, or 13 months after coating.

### B-6—Example 6

In Example 6, a beef aroma 6 was combined under its powder form (‘Aroma 6B’) with a dog dry pet food palatability enhancer (‘PE6’) in appropriate amounts. Pet palatability and the human sensory perception by a trained panel were assessed. PE6 was a dog dry poultry digest obtained by hydrolysis followed by thermal treatment in the presence of Maillard precursors, yet followed by a drying step. PE6 was the ‘Control digest’.

The experimental palatability-enhancing composition (‘PEC’) was obtained by combining Aroma 6B with the Control digest.

The tested PEC (‘PEC 6B’) was as described in Table 17 below.

TABLE 17

| | | PEC 6B |
|---|---|---|
| | Control digest | % of the total |
| | % of the total weight | weight |
| PE6 | 100 | 97 |
| Aroma 6B | 0 | 3 |

B-6-1—Palatability Assessment

Control digest and experimental PEC 6B were dusted at the amount of 1% by weight of dry dog kibbles “dog diet A”, previously coated with 6% poultry fat and 3.3% of a dog liquid poultry digest PE7, to obtain nutritionally-complete and palatable dog dry food products (FPs) Control and 6B. Palatability was assessed in a dog panel as described above in order to compare FP6B to the Control FP, at 1 month after coating. Results of palatability expressed by relative consumption ratios (in %) are presented in Table 18 below.

TABLE 18

| | | |
|---|---|---|
| Relative | Relative | |
| consumption | consumption | Statistical |
| Control FP % | Experimental FP6B % | significance |

Tests 1 month after coating

| | | | |
|---|---|---|---|
| Control FP vs | 41 | 59 | NS |
| FP6B - Day 1 | | | |

‘NS’: not significant

As shown in Table 18, consumptions of Control FP and FP6B were not significantly different, demonstrating that the dry aroma 6 maintained palatability of the food product.

B-6-2—Human Sensory (Appeal) Assessment

FP6B and the Control FP were assessed by an internal human trained panel. The 2 food products (Control FP, FP6B) were presented to 30 trained judges.

Each panelist evaluated the 2 food products in a randomized way (Williams latin square) and scored the preference for the odor type on a scale from 0 to 9 (0: “I don't like at all”-9: “I like it very much”). Means were analyzed with mixed effect Anova (food as fixed effect and judge as random effect) associated with pair wise comparisons with a Duncan correction. Results of the scores given by a human trained panel are presented in Table 19 below.

TABLE 19

| | | | Statistical |
|---|---|---|---|
| | Control FP | FP6B | significance |
| Odor type | 4.29^{a} | 5.68^{b} | * |
| preference after | | | |
| 1 month | | | |

Means sharing same letters in superscript are not significantly different (P>0.05).

As shown in Table 19, panelists preferred the odor of FP6B, with beef aroma “Aroma 6B”, compared to the Control FP.

### B-7—Example 7

In Example 7, a chicken aroma 7 (different from the chicken aromas 1, 2, 5 used in Examples 1, 2, 5 above) was combined under its powder form (‘Aroma 7B’) with a cat dry palatability enhancer (‘PE8’) in appropriate amounts. Pet palatability and the human sensory perception by a trained panel were assessed. PE8 was a cat dry fish digest obtained by hydrolysis followed by thermal treatment in the presence of Maillard precursors, yet followed by a drying step and a mixing step with a pyrophosphate salt. PE8 was the ‘Control digest’. The experimental palatability-enhancing composition (‘PEC’) was obtained by combining Aroma 7B with the Control digest.

The tested PEC (‘PEC 7B’) was as described in Table 20 below.

TABLE 20

| | Control digest | PEC 7B |
|---|---|---|
| | % of the | % of the |
| | total weight | total weight |
| PE8 | 100 | 98.5 |
| Aroma 7B | 0 | 1.5 |

B-7-1—Palatability Assessment

Control digest and experimental PEC7B were dusted at the amount of 2% by weight of dry cat kibbles “cat diet D” (different from the “cat diets A, B of the examples 3 and 5 above, by its formulation and its shape), previously coated with 6% poultry fat, to obtain nutritionally-complete and palatable cat dry food products (FPs) Control and 7B. Palatability was assessed in a cat panel as described above in order to compare FP7B to the Control FP, at 1 month after coating. Results of palatability expressed by relative consumption ratios (in %) are presented in Table 21 below.

TABLE 21
Tests 1 month after coating

| | Relative | Relative | |
|---|---|---|---|
| | consumption | consumption | |
| | Control | Experimental | Statistical |
| | FP % | FP7B % | significance |
| Control FP vs | 50 | 50 | NS |
| FP7B—Day 1 | | | |
| Control FP vs | 54 | 46 | NS |
| FP7B—Day 2 | | | |

NS': not significant

As shown in Table 21, consumptions of Control FP and FP7B were not significantly different, demonstrating that the chicken dry aroma 7 maintained palatability of the food product.

B-7-2—Human Sensory (Appeal) Assessment

FP7B and the Control FP were assessed by an internal human trained panel. The 2 food products (Control FP, FP7B) were presented to trained judges, the panels comprising 23 to 29 judges depending on the period of assessment.

Each panelist evaluated the 2 food products in a randomized way (Williams latin square) and scored the preference for the odor type on a scale from 0 to 9 (0: “I don't like at all”-9: “I like it very much”). Means were analyzed with mixed effect Anova (food as fixed effect and judge as random effect) associated with pair wise comparisons with a Duncan correction. Results of the scores given by a human trained panel are presented in Table 22 below.

TABLE 22

| | | | Statistical |
|---|---|---|---|
| | Control FP | FP7B | significance |
| Odor type | 2.87^{a} | 5.00^{b} | * |
| preference after | | | |
| 1 month⁽²³ | | | |
| ^{judges)} | | | |
| Odor type | 5.52^{a} | 6.03^{b} | * |
| preference after | | | |
| 3 months ⁽²⁹ | | | |
| ^{judges)} | | | |
| Odor type | 4.24^{a} | 5.72^{b} | * |
| preference after | | | |
| 6 months ⁽²⁵ | | | |
| ^{judges)} | | | |
| Odor type | 3.64^{a} | 6.05^{b} | ** |
| preference after | | | |
| 13 months⁽²² | | | |
| ^{judges)} | | | |

Means sharing same letters in superscript are not significantly different (P>0.05).

As shown in Table 22, panelists preferred the odor of FP7B, with chicken aroma 7 “Aroma 7B”, compared to the Control FP, whatever the period tested: 1 month, 3 months, 6 months or 13 months after coating

### B-8—Example 8

In Example 8, a fish aroma 8 was combined under its powder form (‘Aroma 8B’) with a cat liquid palatability enhancer (‘PE9’) in appropriate amounts. Pet palatability and the human sensory perception by a trained panel were assessed. PE9 was a cat liquid fish digest obtained by hydrolysis followed by thermal treatment in the presence of Maillard precursors. PE9 was the ‘Control digest’. The experimental palatability-enhancing composition (‘PEC’) was obtained by combining Aroma 8B with the Control digest.

The tested PEC (‘PEC8 B’) was as described in Table 23 below.

TABLE 23

| | Control digest | PEC 8B |
|---|---|---|
| | % of the | % of the |
| | total weight | total weight |
| PE9 | 100 | 97.5 |
| Aroma 8B | 0 | 2.5 |

B-8-1—Palatability Assessment

Control digest and experimental PEC8B were sprayed at the amount of 3% by weight of dry cat kibbles “cat diet C” (different from the “cat diets A, B, C of the examples 3, 5 and 7 above, by its formulation and its shape), previously coated with 6% poultry fat, and then dusted with a cat dry fish digest PE10 at the amount of 2% by weight of dry cat kibbles, to obtain nutritionally-complete and palatable cat dry food products (FPs) Control and 8B. Palatability was assessed in a cat panel as described above in order to compare FP8B to the Control FP, at 1 month after coating. Results of palatability expressed by relative consumption ratios (in %) are presented in Table 24 below.

TABLE 24
Tests 1 month after coating

| | Relative | Relative | |
|---|---|---|---|
| | consumption | consumption | |
| | Control | Experimental | Statistical |
| | FP % | FP8B % | significance |
| Control FP vs | 48 | 52 | NS |
| FP8B—Day 1 | | | |
| Control FP vs | 60 | 40 | NS |
| FP8B—Day 2 | | | |

NS': not significant

As shown in Table 24, consumptions of Control FP and FP8B were not significantly different, demonstrating that the fish dry aroma 8 maintained palatability of the food product.

B-8-2—Human Sensory (Appeal) Assessment

FP8B and the Control FP were assessed by an internal human trained panel. The 2 food products (Control FP, FP8B) were presented to 26 trained judges.

Each panelist evaluated the 2 food products in a randomized way (Williams latin square) and scored the preference for the odor type on a scale from 0 to 9 (0: “I don't like at all”-9: “I like it very much”). Means were analyzed with mixed effect Anova (food as fixed effect and judge as random effect) associated with pair wise comparisons with a Duncan correction. Results of the scores given by a human trained panel are presented in Table 25 below

TABLE 25

| | | | Statistical |
|---|---|---|---|
| | Control FP | FP8B | significance |
| Odor type | 4.31^{a} | 6.04^{b} | ** |
| preference | | | |
| after 1 month | | | |

Means sharing same letters in superscript are not significantly different (P>0.05).

As shown in Table 25, panelists preferred the odor of FP8B, with fish aroma 8 “Aroma 8B”, compared to the Control FP.

### B-9—Example 9

In Example 9, a bolognese aroma 9 was combined under its powder form (‘Aroma 9B’) with a dog liquid palatability enhancer (‘PE1’), the same as used in Example 1 above, in appropriate amounts. Pet palatability and the human sensory perception by a trained panel were assessed. PE1 was the ‘Control digest’.

The experimental palatability-enhancing composition (‘PEC’) was obtained by combining Aroma 9B with the Control digest.

The tested PEC (‘PEC9B’) was as described in Table 26 below.

TABLE 26

| | Control digest | PEC 9B |
|---|---|---|
| | % of the | % of the |
| | total weight | total weight |
| PE1 | 100 | 96 |
| Aroma 9B | 0 | 4 |

B-9-1—Palatability Assessment

Control digest and experimental PEC9B were sprayed at the amount of 2% by weight of dry dog kibbles “dog diet A”, previously coated with 6% poultry fat, to obtain nutritionally-complete and palatable dog dry food products (FPs) Control and 9B. Palatability was assessed in a dog panel as described above in order to compare FP9B to the Control FP, at 1 month after coating. Results of palatability expressed by relative consumption ratios (in %) are presented in Table 27 below.

TABLE 27
Tests 1 month after coating

| | Relative | Relative | |
|---|---|---|---|
| | consumption | consumption | |
| | Control | Experimental | Statistical |
| | FP % | FP9B % | significance |
| Control FP vs | 40 | 60 | NS |
| FP9B—Day 1 | | | |

NS': not significant

As shown in Table 27, consumptions of Control FP and FP9B were not significantly different, demonstrating that the bolognese dry aroma 9 maintained palatability of the food product.

B-9-2—Human Sensory (Appeal) Assessment

FP9B and the Control FP were assessed by an internal human trained panel. The 2 food products (Control FP, FP9B) were presented to 25 trained judges.

Each panelist evaluated the 2 food products in a randomized way (Williams latin square) and scored the preference for the odor type on a scale from 0 to 9 (0: “I don't like at all”-9: “I like it very much”). Means were analyzed with mixed effect Anova (food as fixed effect and judge as random effect) associated with pair wise comparisons with a Duncan correction. Results of the scores given by a human trained panel are presented in Table 28 below.

TABLE 28

| | | | Statistical |
|---|---|---|---|
| | Control FP | FP9B | significance |
| Odor type | 4.27^{a} | 7.82^{b} | *** |
| preference | | | |
| after 1 month | | | |

Means sharing same letters in superscript are not significantly different (P>0.05).

As shown in Table 28, panelists preferred the odor of FP9B, with bolognese aroma 9 “Aroma 9B”, compared to the Control FP.

### B-10—Example 10

In Example 10, a butter aroma 10 was combined under its powder form (‘Aroma 10B’) with a cat liquid palatability enhancer (‘PE9’), the same as used in Example 8 above, in appropriate amounts. Pet palatability and the human sensory perception by a trained panel were assessed. PE9 was the ‘Control digest’.

The experimental palatability-enhancing composition (‘PEC’) was obtained by combining Aroma 10B with the Control digest.

The tested PEC (‘PEC10B’) was as described in Table 29 below.

TABLE 29

| | Control digest | PEC 10B |
|---|---|---|
| | % of the | % of the |
| | total weight | total weight |
| PE9 | 100 | 98 |
| Aroma 10B | 0 | 2 |

B-10-1—Palatability Assessment

Control digest and experimental PEC10B were sprayed at the amount of 2% by weight of dry cat kibbles “cat diet C”, previously coated with 6% poultry fat, and then dusted with a cat dry fish digest PE10 at the amount of 1% by weight of dry cat kibbles, to obtain nutritionally-complete and palatable cat dry food products (FPs) Control and 10B. Palatability was assessed in a cat panel as described above in order to compare FP10B to the Control FP, at 1 month after coating. Results of palatability expressed by relative consumption ratios (in %) are presented in Table 30 below.

TABLE 30
Tests 1 month after coating

| | Relative | Relative | |
|---|---|---|---|
| | consumption | consumption | |
| | Control | Experimental | Statistical |
| | FP % | FP10B % | significance |
| Control FP vs | 56 | 44 | NS |
| FP10B—Day 1 | | | |
| Control FP vs | 51 | 49 | NS |
| FP10B—Day 2 | | | |

NS': not significant

As shown in Table 30, consumptions of Control FP and FP10B were not significantly different, demonstrating that the butter dry aroma 10 maintained palatability of the food product.

B-10-2—Human Sensory (Appeal) Assessment

FP10B and the Control FP were assessed by an internal human trained panel. The 2 food products (Control FP, FP10B) were presented to 21 trained judges.

Each panelist evaluated the 2 food products in a randomized way (Williams latin square) and scored the preference for the odor type on a scale from 0 to 9 (0: “I don't like at all”-9: “I like it very much”). Means were analyzed with mixed effect Anova (food as fixed effect and judge as random effect) associated with pair wise comparisons with a Duncan correction. Results of the scores given by a human trained panel are presented in Table 31 below.

TABLE 31

| | | | Statistical |
|---|---|---|---|
| | Control FP | FP10B | significance |
| Odor type | 4.09^{a} | 5.29^{b} | * |
| preference | | | |
| after 1 month | | | |

Means sharing same letters in superscript are not significantly different (P>0.05).

As shown in Table 31, panelists preferred the odor of FP10B, with butter aroma 10 “Aroma 10B”, compared to the Control FP.

### B-11—Example 11

In Example 11, a beef aroma 6 was combined under its powder form (‘Aroma 6B’) with a dog powder palatability enhancer (‘PE10’) in appropriate amounts. Pet palatability and the human sensory perception by a trained panel were assessed. PE10 was the ‘Control vegetarian palatability enhancer’.

The experimental palatability-enhancing composition (‘PEC’) was obtained by combining Aroma 6B with the Control vegetarian palatability enhancer.

The tested PEC (‘PEC11B’) was as described in Table 32 below.

TABLE 32

| | Control digest | PEC 11B |
|---|---|---|
| | % of the | % of the |
| | total weight | total weight |
| PE10 | 100 | 96.72 |
| Aroma 6B | 0 | 3.28 |

B-11-1—Palatability Assessment

Control vegetarian palatability enhancer and experimental PEC11B were sprayed at the amount of 0.64% by weight of dry dog kibbles “dog diet A”, previously coated with 8% beef tallow, to obtain nutritionally-complete and palatable dog dry food products (FPs) Control and 11B. Palatability was assessed in a dog panel as described above in order to compare FP11B to the Control FP, at 1 month after coating. Results of palatability expressed by relative consumption ratios (in %) are presented in Table 33 below.

TABLE 33
Tests 1 month after coating

| | Relative | Relative | |
|---|---|---|---|
| | consumption | consumption | |
| | Control | Experimental | Statistical |
| | FP % | FP11B % | significance |
| Control FP vs | 24 | 76 | *** |
| FP11B—Day 1 | | | |

***': very highly significant (p ≦ 0.001)

As shown in Table 33, FP11B was preferred to Control FP, demonstrating that the beef dry aroma 6B did not decrease palatability of food product, thus at least maintained palatability of the food product.

B-11-2—Human Sensory (Appeal) Assessment

FP11B and the Control FP were assessed by an internal human trained panel. The 2 food products (Control FP, FP11B) were presented to 23 trained judges 1 month after coating.

Each panelist evaluated the 2 food products in a randomized way (Williams latin square) and scored the preference for the odor type on a scale from 0 to 9 (0: “I don't like at all”-9: “I like it very much”). Means were analyzed with mixed effect Anova (food as fixed effect and judge as random effect) associated with pair wise comparisons with a Duncan correction. Results of the scores given by a human trained panel are presented in Table 34 below.

TABLE 34

| | | | Statistical |
|---|---|---|---|
| | Control FP | FP11B | significance |
| Odor type | 4.39^{a} | 5.78^{b} | * |
| preference | | | |
| after 1 month | | | |

Means sharing same letters in superscript are not significantly different (P>0.05).

As shown in Table 34, panelists preferred the odor of FP11B, with beef aroma 6 “Aroma 6B”, compared to the Control FP.

### CONCLUSION

As shown in the examples 1 and 2, the combination of a dry food aroma with a pet food palatability enhancer in different pet food product preparations enables to produce a pet food product having an improved appeal to pet owners while at least a maintained palatability to pets, in comparison with said pet food product which comprises said food aroma under its liquid form.

As shown in the examples 3 to 11, different liquid or dry palatability-enhancing compositions comprising or consisting of at least one dry food aroma and at least one pet food palatability enhancer (PE) in (in particular coated on) various pet food product preparations enable to improve appeal to pet owners while at least maintaining palatability to pets of a pet food product, in comparison with said pet food product which does not comprise said dry food aroma (i.e. in comparison with the same pet food product, which only differs by the fact that it does not comprise said dry food aroma).

The effect of increased appeal to pet owners combined to at least a maintained palatability to pets of a pet food product can be obtained with different liquid or dry palatability enhancing compositions comprising at least one dry food aroma and at least one pet food palatability enhancer, in (in particular coated on) various pet food product preparations, demonstrating the large range of applications of said palatability enhancing compositions in pet food products.

Said pet food products obtained with different liquid or dry palatability enhancing compositions comprising at least one dry food aroma and at least one pet food palatability enhancer in (in particular coated on) various pet food product preparations, exhibits a sustained improved appeal to pet owners while at least a maintained palatability to pets (in comparison with said pet food product which does not comprise said dry food aroma) over time, in particular at least over 3 months, more particularly at least over 6 months, yet more particularly at least over 9 months and even more particularly at least over 12 months (Examples 3, 4, 5 and 7).

1-20. (canceled)

21. A method for improving appeal to pet owners while at least maintaining palatability to pets of a pet food product, comprising the step(s) of:
combining at least one dry food aroma to at least one pet food palatability enhancer to obtain a palatability-enhancing composition; and
adding, in particular by coating, said palatability-enhancing composition to a pet food product preparation to obtain said pet food product;
in comparison with said pet food product which does not comprise said dry food aroma.

22. The method according to claim 21, wherein said dry food aroma is chosen from the group consisting of animal dry aromas, vegetable dry aromas and dairy dry aromas.

23. The method according to claim 22, wherein said animal dry aromas are chosen from the group consisting of beef dry aromas, poultry dry aromas, pork dry aromas and marine dry aromas.

24. The method according to claim 22, wherein said vegetable dry aromas are chosen from the group consisting of herbs dry aromas and fruits and vegetables dry aromas.

25. The method according to claim 22, wherein said dairy dry aromas are chosen from the group consisting of butter dry aromas, milk dry aromas and cheese dry aromas.

26. The method according to claim 21, wherein said pet food palatability enhancer is chosen from the group consisting of animal palatability enhancers and vegetarian palatability enhancers.

27. The method according to claim 26, wherein said animal palatability enhancers are chosen from the group consisting of animal digests, animal fats and dairy products.

28. The method according to claim 21, wherein said palatability-enhancing composition comprises from 0.25 to 20% by weight of said dry food aroma based on the total weight of said composition.

29. The method according to claim 28, wherein said palatability-enhancing composition comprises from 0.5 to 15% by weight of said dry food aroma based on the total weight of said composition.

30. The method according to claim 29, wherein said palatability-enhancing composition comprises from 1 to 10% by weight of said dry food aroma based on the total weight of said composition.

31. The method according to claim 21, wherein said palatability-enhancing composition comprises from 80 to 99.75% by weight of said pet food palatability enhancer based on the total weight of said composition.

32. The method according to claim 31, wherein said palatability-enhancing composition comprises from 85 to 99.5% by weight of said pet food palatability enhancer based on the total weight of said composition.

33. The method according to claim 32, wherein said palatability-enhancing composition comprises from 90 to 99% by weight of said pet food palatability enhancer based on the total weight of said composition.

34. The method according to claim 21, wherein the weight ratio of said dry food aroma to said pet food palatability enhancer is from 0.25:99.75 to 20:80

35. The method according to claim 34, wherein the weight ratio of said dry food aroma to said pet food palatability enhancer is from 0.5:99.5 to 15:85.

36. The method according to claim 35, wherein the weight ratio of said dry food aroma to said pet food palatability enhancer is from 1:99 to 10:90.

37. The method according to claim 21, wherein said pet food product comprises from 0.25 to 12% by weight of said palatability-enhancing composition based on the total weight of said pet food product.

38. The method according to claim 37, wherein said pet food product comprises from 0.5 to 8% by weight of said palatability-enhancing composition based on the total weight of said pet food product.

39. The method according to claim 38, wherein said pet food product comprises from 0.5 to 5% by weight of said palatability-enhancing composition based on the total weight of said pet food product.

40. The method according to claim 21, wherein said pet is a cat or a dog.

41. A method for preparing a pet food product comprising the step(s) of:
combining at least one dry food aroma to at least one pet food palatability enhancer to obtain a palatability-enhancing composition; and
adding, in particular by coating, said palatability-enhancing composition to a pet food product preparation to obtain a pet food product;
wherein said pet food product has an improved appeal to pet owners while at least a maintained palatability to pets, in comparison with said pet food product which does not comprise said dry food aroma.
